(19) United States
(12) Patent Application Publication
(10) Pub. No.: US 2010/0231904 A1
(43) Pub. Date: Sep. 16, 2010

(54) Method and Device for Measuring Hydrocarbons in Aqueous Solutions

(76) Inventors: COLIN C. TYRIE, HOUSTON, TX (US); JEFFERSON D. KEATHLEY, HOUSTON, TX (US)

Correspondence Address: MARK O. LOFTIN, 2370 HILLCREST RD., STE. G#317, MOBILE, AL, 36695, US

(21) Appl. No.: 12/402,860

(22) Filed: Mar. 12, 2009

(51) Int. Cl. G01J 3/42; G01N 1/10

(52) U.S. Cl. 356/319; 356/246

(57) ABSTRACT

The present invention relates to a method and device for conducting the analysis of hydrocarbons in aqueous solutions, accurately matching the EPA Test Method 1664 HEM, without the need for a solvent extraction step. The solvent extraction step is eliminated by: 1) delivering the aqueous solution directly to a standard cuvette in a controlled and convenient manner, and 2) correlating the analyzer's output reading to a predetermined calibration curve. The predetermined calibration curve is generated by having a duplicate sample of aqueous solution tested by Method 1664 and the present device and the two values correlated. The sample delivery system is comprised of a standard 1-liter sample bottle, a flow control section, and an analyzer adapting section. The sample bottle contains the aqueous solution to be analyzed. The flow control section has various conduits which allow the user to regulate the rate at which the sample flows through to the analyzer using gravity and contains an optional fill line which can be connected directly to the process that generates the aqueous media being tested. The analyzer adapting section connects the flow control section to a standard round glass cuvette and provides a sealing means. A method for using the device is presented which calls for taking multiple analyzer readings at timed intervals as the aqueous solution flows through the cuvette. The values are then averaged and compared to the Method 1664 calibration data. Accuracy of this method to the Method 1664 can be maintained with periodic recalibration, typically monthly.

### TECHNICAL FIELD

The present invention relates to devices and methods for obtaining liquid samples from a process for quantitative or qualitative analysis. More specifically, the present invention is directed to devices and methods that facilitate sampling of the liquid from the process for presentation of that sample to an analyzer. The functional aspects of such sampling devices are largely dictated by the requirements of the test method to which they are employed. Also the type of analyzer they supply the liquid sample to and the physical properties of the liquid being sampled from the process. For many sampling devices, their primary objectives are reduction of human labor time, human health and safety issues related to toxicants exposure and fire hazards (i.e. solvents and acids). Further the reduction of generated waste, waste disposal, reduction of sampling and volumetric solvent extraction errors. The improvement of analyzer accuracy and repeatability, plus minimizing associated costs of the analysis.

In an oil production process where one must meet an oil and grease limit for produced water discharges, treating equipment is needed to remove oil from the water prior to that discharge. The operation of such equipment requires a quick, simple method for testing equipment performance in the field. Operators must also monitor the performance of their water treatment equipment frequently. Many production operations result in changes in water quality that may require adjustment of the water treatment process. Although many treatment systems are stable enough to operate for several days without adjustment, operators do monitor their treatment systems several times daily in order to ensure that the equipment is functioning within the set parameters that were originally specified.

Method 1664 HEM is the Environmental Protection Agency's (EPA) official test protocol for analyzing oil and grease in aqueous media. However, this method is poorly suited for field monitoring because it is time consuming and labor intensive. To conduct this test method properly requires significant training, practice, and space. Additionally, conducting the test on off-shore platforms is both unsafe and impractical due to the platform's constant vibration which is incompatible with the sensitive weighing scales required by the test method. To avoid these problems, producers send samples to an on-shore laboratory. However, this process can take several days and cannot provide the rapid data operators need to make adjustments, if necessary, to the operating equipment to avoid discharging oil into the environment.

### BACKGROUND ART

When the EPA developed the National Pollutant Discharge Elimination System (NPDES) in the 1970s, oil and grease in produced water was one of the pollutants whose discharge into the environment because regulated. Unlike other parameters, “Oil and Grease” is a technical term and not a unique chemical entity. This term refers to a mixture of chemicals and petroleum hydrocarbons that vary from source to source and is defined by the test method used to analyze the mixture. Governmental restrictions on the discharge of oil and grease have made it necessary to develop processes that effectively remove these materials from produced water that is discharged back into the environment. As with any chemical separation process, analysis methods are needed to measure their effectiveness and to control them. However, for produced water separation equipment, EPA Method 1664 HEM is not practical due to its complexity and time requirements for field monitoring. Therefore, most equipment operators have adopted some type of field method using Freon as an extractant and a measurement using an infrared (IR) instrument. Although these methods do not measure “oil and grease” as defined by EPA Test Method 1664, the results obtained using them can be correlated with oil and grease concentrations.

Because Freon has been found to be a hazard to the ozone layer, its manufacture has been banned in the United States. This has resulted in the EPA developing a new official method (EPA 1664 HEM) that uses n-hexane solvent as an extractant. The industry also has been actively searching for replacements for field methods.

The EPA defined oil and grease when the first guidelines for permits were issued in the 1980's. The method specified for measuring oil and grease was EPA Method 413.1. The EPA officially changed the method for measuring oil and grease from Method 413.1 to Method 1664 HEM. Method 413.1 specifies that a one-liter water sample be acidified to a pH less than 2 and extracted with three 30 ml portions of Freon. The Freon was to be evaporated under specified conditions and the resulting residue of oil and grease was to be weighed. Method 1664 HEM is very similar but uses hexane as the extracting solvent. Only those materials which are soluble in n-hexane at pH 2 or less and remain after boiling off the solvent constitute “oil & grease.” Produced waters commonly contain organic constitutes in concentrations of 2,000 to 3,000 mg/l. These organic constitutes include such materials as dispersed droplets of crude oil, dissolved carboxylate material (organic acids, including aromatic acids, and dissolved phenols), dissolved aromatic compounds (including multi-ring compounds such as naphthalene), and residual treating chemicals. In fact, much of the organic content in produced water is not “oil and grease” because many of these organic compounds are either insoluble in the extracting solvent (n-hexane) or they are sufficiently volatile that they are vaporized when distilling away the extraction solvent. Therefore, what compounds constitute “oil and grease” depends not only on the chemical composition of the water, but also on the extraction procedure used in the analysis. EPA Method 1664 is a direct method applicable to aqueous matrices that requires the following steps: n-hexane extraction, solvent evaporation, and residue weighing. Other extraction and concentration techniques are allowed, provided that all performance specifications are met and can be correlated to basic n-hexane method. In addition, Method 1664 contains certain quality control (QC) provisions designed to monitor precision and accuracy. Most other methods used to measure oil and grease are indirect methods, meaning they measure some property of the constituents of oil and grease that can be correlated to oil and grease. For example, infrared measures the concentration of carbon-hydrogen bonds in the extract. Since all constituents of oil & grease contain carbon-hydrogen bonds all of them are detected by infrared. The EPA's definition of oil and grease is not universally used. For the North Sea the Oslo-Paris Commission (OSPARCOM) and in China oil and grease is defined by infrared measurements.

The official EPA method for measuring oil and grease measure the oil and grease by weighing it. That is, the property measured is mass or weight. All field methods measure some other property of oil and grease. Some of the measuring principles employed by field methods and the property they measure area:

| Measurement Principle | Property Measured |
|---|---|
| Infrared | Number of C—H bonds |
| Ultra Violet absorbance | Concentration of aromatic |
| | compounds |
| Ultra Violet fluorescence | Concentration of aromatic |
| | compounds |
| Visible Light absorbance | Color |
| Nephelometry | Concentration of particles or |
| | drops |

In order to determine the concentration of “oil & grease” as defined by the EPA method, the analyst must first determine the relationship between what the defining method measures and what the instrumental method measures. This means that for each measurement technology a condition has to be met for a relationship to exist. For the measurement technologies listed above the conditions to be met are approximately:

| Measurement Principle | Condition |
|---|---|
| Infrared | The number of C—H bonds in the O&G is |
| | proportional to the weight of O&G. |
| Ultra Violet absorbance | Concentration of aromatic compounds is |
| | proportional to the weight of O&G. |
| Ultra Violet fluorescence | Concentration of aromatic compounds is |
| | proportional to the weight of O&G. |
| Visible Light absorbance | The color of the extract is proportional to the |
| | weight of O&G. |
| Nephelometry | The number of oil droplets is proportional to |
| | the weight of O&G. |

None of these conditions are exactly true in all cases.

The term “Oil and Grease” contained within a water sample is defined by the U.S. EPA Method 1664 HEM as “(t) hose materials in water that are soluble in n-Hexane at pH 2 or less and remain and weighed after the solvent is evaporated at 85° C. for at least 30 minutes and the extractant is dehydrated”. To meet this definition, the analyzer for any alternate test method must be calibrated to correlate with the Method 1664 results. In a typical Method 1664 HEM analysis, a human operator retrieves a duplicate set of samples when retrieving the water to be sent in to and officially nominated laboratory. This fluid along with the official sample is taken from the water discharge line, the pH lowered as described using Hydrochloric or Sulfuric acid. The samples are placed on ice in a cooler and shipped to a laboratory on shore via helicopter or ship. A lab technician then adds a fixed quantity of an extraction solvent, such as n-hexane. The water and solvent are shaken together for two minutes within a glass seperatory funnel. The oil and grease impurities within the water phase are collected within the insoluble solvent phase. The vessel is allowed to rest and a small sample of the extraction solvent is loaded into a second vessel called a cuvette. The cuvette is then placed inside an analyzer and exposed to a light beam of a specific wavelength. Depending on the light wavelength, the oil absorbs the light or fluoresces in proportion to the concentration of oil in the extraction solvent.

It is well known in the art of oil-in-water analysis that effective monitoring of a production process requires frequent analytical work, which is both labor intensive and costly. Some complex analyzers are available that can measure the oil content in water continuously without the use of solvents, but they are very expensive and often require cleaning of lenses and filters to maintain their accuracy.

What is needed in the art is a practical device for sampling the produced water from the process and a method for using the device to achieve an accurate reading without the need for an extraction solvent as called for under the EPA 1664 Test Method.

What is further needed in the art is a method and device for simplifying the sampling and measuring of the oil content in produced water, as accurately as possible, so that human labor time and training are minimized.

What is further needed in the art is a reusable device and procedure that produces results accurately and consistently without the need for frequent re-calibration.

What is further needed in the art is an economical device that produces and accurate and repeatable reading without requiring a significant investment in capital or human resources and can utilize common analyzer devices found in oil production facilities.

By eliminating the solvent extraction step and minimizing human involvement in the analysis, oil production companies can economically analyze their wastewater more frequently at a lower cost. More frequent analyses will reduce the undetected duration of process upsets, lower the amount of oil discharged into public waters, and better ensure

### DISCLOSURE OF THE INVENTION

According to various features and embodiments of the present invention, the present invention provides a fluid sampling device that includes a bulk sample container, a sample flow control section and a sample presentation section. The bulk sample container can be any practical volume, but is typically 1-2 liters when used for the EPA Method 1664 test. Whatever the practical sample volume used, it should be known to the operator and recorded so that calibration and calculations can be performed subsequently once the readings are taken. The sample flow control section contain several sub-assemblies which regulate flow from the bulk sample container and deliver a smaller known volume to the sample presentation. The sample flow control section also includes a vent control valve for allowing air or other gas into the bulk sample chamber so as to allow gravity flow of the sample into the lower chamber within the sample flow control section. This section also contains an outlet valve for draining the sample from the lower chamber once the spectrometer reading is taken. The sample presentation section is comprised of a number of embodiments that correspond to the type of spectrophotometric analyzer being used by the operator. For example, common hand-held UV spectrophotometers require the liquid be presented within an 8 mm square glass cuvette. This cuvette is attached to the sample flow control device and is sealed using o-rings to prevent leakage of the sample into the analyzer inlet port. Once the cuvette is placed in the analyzer's inlet port, the sample reading is taken. Once the sample reading is complete, the drain valve is opened and the sample is discharged. Once discharged, the drain valve is closed and the vent valve is opened to allow the contents of the sample container to flow into the lower chamber for the next reading. Typically, multiple readings are taken for the entire contents of the bulk sample container and the analyzer's results averaged. The spectrophotometer measures the absorbance of UV wavelength light by the aromatic compounds present in the dispersed oil droplets. The analyzer is typically calibrated by performing an EPA Method 1664 analysis on the same sample and comparing it to the reading obtained from the UV spectrophotometer.

### BRIEF DESCRIPTION OF DRAWINGS

The present invention will be described with reference to the attached drawing which is given as non-limiting example only, in which:

FIG. 1 is a side view of a sampling device according to one embodiment of the present invention.

### BEST MODE FOR CARRYING OUT THE INVENTION

The present invention is directed to methods and devices for sampling fluids from either a process line or other such fluid source. Although applicable to other liquid sample analyses, for purpose of demonstrating this mode, the analysis of produced water for trace quantities of produced oil (hydrocarbons) shall be described. The methods and devices of the present invention are particularly useful for sampling produced water for purpose of testing the samples for oil concentration and allowing producers to comply with EPA Test Method 1664.

The components of the sampling device are all made of inert materials such as Teflon, glass or metal, which will not contribute to contamination of any fluid sample contained within the sampling device. Moreover, these materials can be readily cleaned between sampling procedures and will not retain contaminants within their structure that might cause false readings on subsequent tests. Furthermore, the components are relatively small so that the sampling device can by packed and field assembled for use.

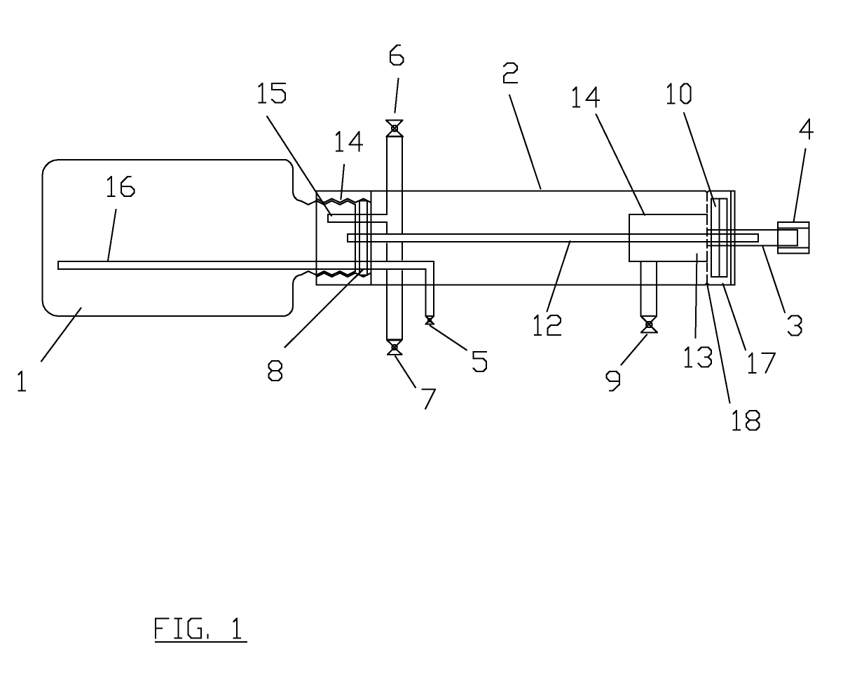

FIG. 1 shows the three general sections of the sampling device: a removable bulk sample container 1, a sample delivery block 2, and a removable sample presenting section 17. In the preferred embodiment, the bulk sample container has a collective volume of at least 1 liter. Other volumes may be selected based on the particular test being performed and the number of repeat measurements desired by the test operator for a given sample. The bulk sample container is a standard laboratory sample bottle comprised of a cylindrically shaped container and a narrower neck section with an integral male threaded top. In the preferred embodiment, the threads are those typical of analytical sample bottle tops or caps or can be customized to smaller thread spacing to provide for improved sealing for higher pressure applications.

The sample delivery block 2 contains a female socket 14 that receives the male threads of the bulk sample container 1. Although the preferred embodiment demonstrates the standard sample bottle thread design, it is understood that other known connecting means, such as flanges, quick-disconnects, rubber inserts, mating clamps, or other such connecting means may be also employed. The function of this connection is to allow the sample within the bulk container to be transferred to the sample flow control section without leaking and to allow the container to be easily removed to facilitate cleaning, manual filling and emptying. The embodiment of FIG. 1 shows a standard sample bottle with a washer or gasket 8 made of a compressive material is placed in the base of the female socket 14. A leak-proof seal is formed when the lip of the bulk sample container inserted into the female socket 14 is torque against the gasket using the matching threads. Extending into the bulk sample container from the flow control section are three tubes, the sample delivery conduit 12, the bulk container drain vent tube 16, and the optional sample inlet conduit 15. The sample delivery conduit 12 transfers the material from the bulk sample container, through the sample delivery block 2 and into the sample presenting section 17. Flow through this tube occurs when a liquid sample is present in the bulk container, the sample vent valve 5 is opened, and the sample drain valve 9 is opened. Air flows into the bulk container through the drain vent tube 16 to equalize the vacuum caused by gravity flow of the liquid sample out of the bulk container. After a brief flush time, the sample drain valve or the sample vent valve can be closed and flow from the sample container will cease.

Flow into and out of the bulk container can also occur through the optional sample inlet conduit 15. This conduit has one inlet port containing and inlet valve 6 and two outlet ports. One outlet port extends into the bulk sample container and the other outlet port is connected through an outlet valve 7 to a drain preferably or to a lower pressure point somewhere in the production process for recycling the sample. Flow of the process liquid being analyzed is established by opening the outlet valve 7 and throttling the inlet valve 6. After flushing the line for a short period, the flow can then be made to go into the bulk sample container 1 by opening the bulk container drain vent tube 16. Opening this valve allows the escape of displaced air or other gases within the empty bulk container as the liquid begins to occupy space. Typically, the container has a visible mark placed on it so that the operator is aware when the sample reaches the desired volume.

In continued reference to FIG. 1, the sample delivery block 2 is a solid object into which the various flow conduits and void volumes are constructed. It can be fabricated of a number of machinable materials, such as metals and plastics. The void volume 13 is a cylindrical chamber which provides a collection point for sample flowing up from the cuvette 3 during operation of the device. Sample exits this chamber to the drain via the sample exit valve 9. When the liquid to be analyzed has filled the bulk sample container to the desired level or the sample bottle with the sample is secured in place, the device is orientated vertically with the liquid sample bottle point downward. The device can be held in this vertical orientation by means of a common laboratory ring stand. To prevent leakage of the sample through the various interconnections of the device, a series of o-rings are used to provide a sealing surface. An o-ring 10 is placed inside the base of the removable sample presenting section 17. This o-ring both holds the cuvette in place and prevents leakage of sample liquid out of the cuvette 3. A second o-ring 18 is placed around the sample delivery block and is compressed when the removable sample presenting section 17 is screwed on and tightened. The cuvette 3 is sized to fit securely within the inlet diameter of the analyzer's inlet port 4 according to the analyzer manufacturer's requirements for ensuring rejection of interfering light frequencies.

Sequence for Calibrating the Device to EPA Method 1664 HEM Test.

To maintain accuracy of the readings obtained using the present invention, periodic calibration is required. The method of calibrating the invention, as applied to the measurement of hydrocarbons in produced water as an alternative to EPA Test Method 1664 is as follows:

Step 1: Fill 3 one-liter sample bottles with the produced water to be analyzed.
Step 2: Send 2 of the filled sample bottles to an accredited lab for EPA Method 1664 analysis and request the clean produced water to be returned after the analysis.
Step 3: Use the clean produced water (i.e., after the hexane extraction step performed by the lab during the Method 1664 test) as the “blank” for establishing the “zero-point” concentration.
Step 4: When the lab's Method 1664 analysis results are received and the clean produced water returned, transfer a sample of the “blank” to the bulk sample container and flow a portion through the unit making sure the cuvette is full of liquid. Following the procedures of the UV spectrophotometer manufacture, record (program) the absorbance reading of blank and drain the sample container's contents.
Step 5: Transfer the third bottle of produced water sample taken in Step 1 into the bulk sample container and run a portion of the sample through the device to ensure the cuvette is full of liquid. Following the procedures of the UV spectrophotometer manufacture, record the absorbance reading and program in the value for that reading as obtained from the laboratory's Method 1664 analysis.

This calibration procedure should be carried out preferably once per month. Note that if the sample bottles used in Step 1 are the same sample bottles that comprise the bulk sample container, then the transfer of the samples from one bottle to the other will not be required and the sample bottles can simply be screwed into the female socket 14 and secured by the matching receiving threads.

Operating Sequence for Using the Device to Measure “Oil & Grease” in Producer Water

After calibrating the UV analyzer according to the aforementioned steps, a sample of produced water can be accurately analyzed for hydrocarbons without the need for a solvent extraction step using the present invention and the following procedure. This procedure is annotated in reference to FIG. 1:

Step 1: Close valves 6, 7, and 9.
Step 2: Separate the bulk sample container 1 from the rest of the device and invert so that attachment of a new bulk sample container can occur without leakage of the liquid content prior to the seal 8 is made. In most cases, the sample will be taken in a disposable bulk sample bottle with threads that match the female socket 14. However, if the sample is extracted from the process in a different container that does not have a compatible attachment means, the produced water sample may require transfer from the original container into a compatible bulk sample bottle. In either case, the compatible bulk sample container is then attached to the flow control section 2 and the device is inverted so that flow from the bottle will occur under the force of gravity. In one embodiment, a standard “ring stand” is used to hold the device assembly vertical and in-place. The ring stand can be adjusted vertically to accommodate the height necessary to fit the cuvette 3 into the analyzer's sample transition piece 4 and cuvette receiving slot. The ring portion of the stand rests against the taper of the bulk sample container's neck section. The weight of the base of the ring stand is increased until the weight of the device and sample together are stable enough for the operator to work safely with.
Step 3: Turn the UV analyzer on according to the manufacture's procedures. The analyzer should read “0” since no sample is present.
Step 4: Open the sample vent valve 5 and the sample drain valve 9 to start the flow of the sample through the system. Adjust the flow rate by modulating the sample drain valve 9. Although continuous flow is not necessarily required, in many cases, the operator may prefer to record analyzer readings with a continuous flow depending on the objective of the analysis. The rate at which the sample flow is set would depend on the time the operator desired to complete the test. In one embodiment, with the drain valve and vacuum valve wide open, the unit will process one liter of water in approximately 2 minutes.
Step 5: While the sample is flowing through the device and the analyzer, the absorbance reading (or the hydrocarbon reading as interpreted by the spectrophotometer's conversion of the absorbance to a number on the analyzer's display) is taken according to the manufacturer's operating procedures. These sequential readings are preferably logged and the highest and the lowest readings discarded. The remaining numbers are then averaged to obtain an average reading of the entire sample.

In another embodiment of the invention, the readings are not averaged, but recorded individually to produce an assessment of how hydrocarbons may be dispersed within a three-phase separator process vessel. A sample of the process vessel's inlet liquid is placed within the bulk sample container and allowed to settle for a specified time. Since hydrocarbons are typically of lighter density than water and are insoluble, they tend to float to the top of the sample. As the contents of the container are drained through the cuvette, readings are taken at various heights of the bulk container, which allows the assessment of degree of phase separation and residual stratification that might be occurring for a given fluid mixture. When used in this manner, the present invention becomes a useful tool for analyzing equipment performance and troubleshooting process upsets.

What is claimed is:

1. A portable fluid sampling device for the measurement of hydrocarbons in aqueous solutions comprised of:
a bulk sample container having an open end for receiving a sample to be analyzed,
a flow controller having a first end for connecting to the open end of the bulk sample container, a vent conduit projecting into the bulk sample container for transport of air, an axial fluid conduit for transferring the liquid contents of the bulk sample container to the second end of the flow controller, and a return drain chamber adjacent to the second end for receiving the analyzed solution and discharging the aqueous solution to an external source, and
a cuvette adapter attached to the second end of the flow controller to receive the aqueous solution exiting the axial fluid conduit having first end with a sealed connection to the flow controller and a transparent second end for presentation of the aqueous solution to a spectrophotometric analyzer.

2. The portable fluid sampling device in claim 1 where the flow controller further comprises a sample supply conduit having an inlet end for receiving a solution from a external source, a first outlet end for discharging excess solution coming from the source, and a second outlet end projecting into the bulk sample container so that the solution can be loaded directly into the bulk sample container without requiring pre-separation of the bulk sample container from the flow controller.

3. The portable fluid sampling device of claim 1, wherein the bulk sample container is comprised of a standard laboratory sample bottle and is mechanically coupled to the flow controller using the threads of the bottle's inlet port.

4. The portable fluid sampling device of claim 3, wherein an o-ring of compressible material is placed between the top edge of the sample bottle and the first end of the flow controller to provide a sealing means for preventing escape of solution within the bulk container through the bottle inlet port threads.

5. The portable fluid sampling device of claim 1, wherein the flow controller is fabricated from a solid cylinder of metal or thermoplastic that is inert to the solution being analyzed.

6. The portable fluid sampling device of claim 1, wherein the means to hold the assembly securely in the vertical orientation during operation is a laboratory ring stand where the ring supports the tapered portion of the bulk sample container.

7. The portable fluid sampling device of claim 1 wherein the first end of the cuvette adapter is comprised of male threads which are inserted into corresponding female threads in the second end of the flow controller and an o-ring of compressible materials placed there between such that a secure seal is formed when the cuvette adapter and flow controller are tightened together.

8. The portable fluid sampling device of claim 1 wherein the analyzed solution flowing from the cuvette adapter exits the flow controller through a drain conduit into which a valve is placed and modulated to control the flow rate of solution through the cuvette adapter.

9. The portable fluid sampling device of claim 1 wherein the bulk sample container has a working sample volume of between 1,000 and 2,000 milliliters inclusive.

10. A method of duplicating the results of a solvent extraction-based test method for analyzing the concentration of dilute hydrocarbons in an aqueous solution using a spectrophotometric analyzer without the use of a solvent comprising the steps of:
a) Pre-calibrating the spectrophotometric analyzer to the solvent-based test method to be correlated,
b) Flowing a controlled continuous rate of the aqueous solution to be analyzed through the spectrophotometric analyzer,
c) Over a fixed period of time, record the spectrophotometric analyzer's readings at repeated intervals, and
d) Discard the highest and lowest readings recorded and calculate the numeric average of the remaining values recorded.

11. The method of claim 9 wherein the step of Pre-calibrating the spectrophotometric analyzer to the solvent-based testing method being emulated is further comprised of the steps:
a) Filling three sample bottles with the aqueous solution to be analyzed at a sufficient volume according to the solvent-based test method to be emulated;
b) Sending two of the collected sample bottles to an accredited lab for conducting the solvent-based extraction test to be emulated and have the laboratory return the aqueous layers after they have been extracted by the test solvent;
c) Adding a portion of the returned aqueous phases to the spectrophotometric analyzer per manufacturer's requirements and calibrate the reading as the “zero” or “blank” point;
d) Establishing a controlled flow of the remaining original sample obtained in the first step through the analyzer and record the absorbance readings at periodic intervals until the solution is depleted from the sample bottle;
e) Discarding the highest and lowest absorbance readings and calculate the numerical average of the remaining values; and
f) Programming the calculated average absorbance reading of the sample as the “ppm hydrocarbon” reading displayed on the analyzer per the manufacturer's procedures.

12. The method of claim 10 where in step “c” is further comprised of a sample time interval of at least 2 minutes for a 1 liter sample of time.

13. The method of claim 10 where the number of analyzer readings recorded is at least 10.

14. A method of determining the stratification of hydrocarbons within a container of aqueous solution using a spectrophotometric analyzer comprising the steps of:
a) Extracting a sample of the aqueous solution with a volume of an immiscible hydrocarbon-soluble solvent,
b) Transferring a portion of the extracted aqueous solution to the analyzer and programming the absorbance reading as the analyzer “blank.”
c) Collecting a sample of the aqueous solution containing the hydrocarbons to be analyzed into a container.
d) Allowing the sample to rest for a period of time that is at least as long as the residence time of the process container being analyzed.
e) Flowing a controlled continuous rate of the aqueous solution to be analyzed through the spectrophotometric analyzer,
f) Over a fixed period of time, recording the spectrophotometric analyzer's absorbance readings at consistent intervals, and
g) Plotting the absorbance readings measured versus time to generate a display of the varying levels of hydrocarbon content within the depth of the aqueous solution sampled.
